(19) United States
(12) Patent Application Publication
(10) Pub. No.: US 2010/0166314 A1
(43) Pub. Date: Jul. 1, 2010

(54) Segment Sequence-Based Handwritten Expression Recognition

(75) Inventors: Yu Shi, Beijing (CN); Frank Kao-Ping Soong, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/346,376

(22) Filed: Dec. 30, 2008

(51) Int. Cl. G06K 9/00

(52) U.S. Cl. 382/189; 382/187

(57) ABSTRACT

Methods and apparatuses for generating, by a computing device configured to interpret a handwritten expression, a symbol graph to represent strokes associated with the handwritten expression, are described herein. The symbol graph may include nodes, each node corresponding to a combination of a stroke and a candidate symbol for that stroke. The computing device may also generate a segment graph based on the symbol graph by combining nodes associated with a same stroke if strokes of their preceding nodes are the same. Also the computing device may perform a structure analysis on at least a subset of segment sequences represented by the segment graph to determine hypotheses for the handwritten expression. In other embodiments, rather than generate a segment graph, the computing device may determine segment sequences by selecting a number of symbol sequences from the symbol graph and combining symbol sequences having the same segmentation.

### BACKGROUND

Personal Computer (PC) Tablets, Personal Digital Assistants (PDAs) and other computing devices that use a stylus or similar input device are increasingly used for data input. Data input using a stylus or similar device is advantageous because inputting data via handwriting is easy and natural. Handwritten data input includes conventional text, such as the handwritten expressions of spoken languages (for example, English words), as well as handwritten mathematical expressions.

These handwritten mathematical expressions, however, present significant recognition problems to conventional computing devices. Such devices with conventional handwriting-recognition software packages fail to recognize mathematical expressions with a high degree of accuracy. In general, conventional computing devices have particular difficulty in accurately and effectively recognizing handwritten mathematical expressions because the information contained in a handwritten mathematical expression is often interdependent and interrelated. For example, while the interpretation of a handwritten mathematical expression is often based upon the interdependence the expression's symbols themselves, the relationship between the symbols-which is often specified by the relative positioning symbols-plays a role in that interpretation as well.

### SUMMARY

In various embodiments, a computing device configured to interpret a handwritten expression may generate a symbol graph to represent a plurality of strokes associated with the handwritten expression. The symbol graph may include a plurality of nodes, each node corresponding to a combination of a stroke and a candidate symbol for that stroke. The computing device may further generate a segment graph based on the symbol graph by combining nodes associated with a same stroke if strokes of their preceding nodes are the same. Also, in some embodiments, the computing device may perform a structure analysis on at least a subset of a plurality of segment sequences represented by the segment graph to determine a set of hypotheses for the handwritten expression. In some embodiments, rather than generate a segment graph, the computing device may determine a plurality of segment sequences by selecting a number of symbol sequences from the symbol graph and combining symbol sequences having the same segmentation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF DRAWINGS

Non-limiting and non-exhaustive examples are described with reference to the following figures:

FIG. 1 is a block diagram illustrating an overview in accordance with various embodiments;

FIG. 2 is a flowchart view of a first set of exemplary operations associated with the overview shown in FIG. 1, in accordance with various embodiments;

FIG. 3 is a flowchart view of a second set of exemplary operation association with detecting fixed-length records, in accordance with various embodiments;

FIG. 4 illustrates an exemplary symbol graph, in accordance with various embodiments;

FIG. 5 illustrates an exemplary segment graph of the symbol graph shown in FIG. 4, in accordance with various embodiments;

FIG. 6 illustrates an exemplary user interface (UI) that allows a user to input a handwritten expression into a computing device and to confirm that the computing device recognized the expression, in accordance with various embodiments; and

FIG. 7 is a block diagram of an exemplary computing device.

### DETAILED DESCRIPTION

### Overview

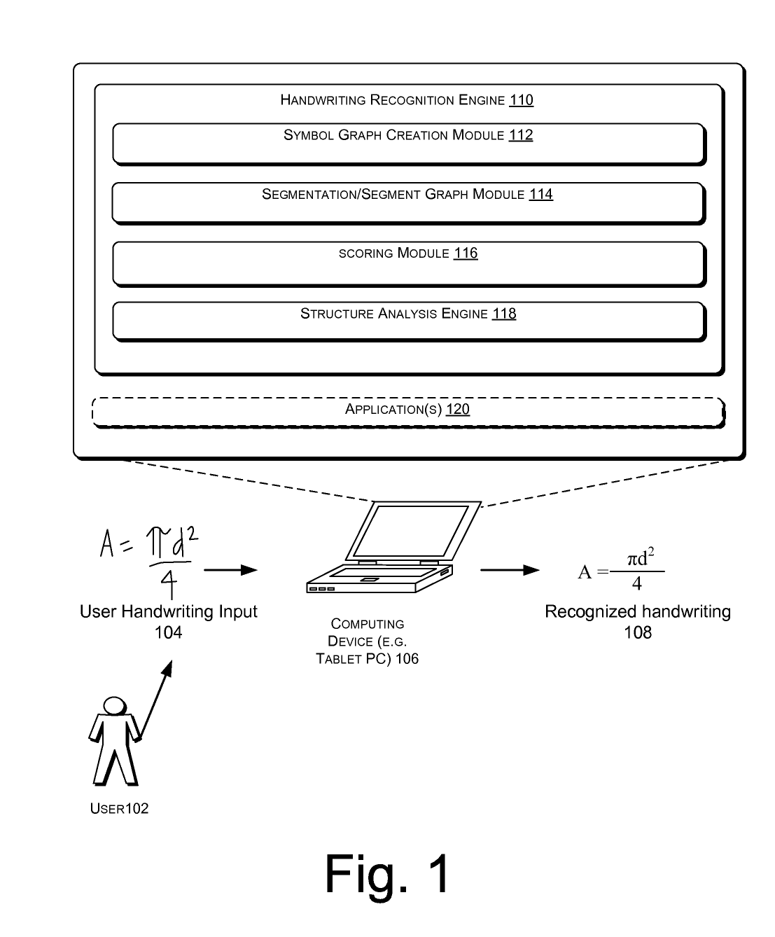

FIG. 1 is a block diagram illustrating an overview in accordance with various embodiments. More specifically, FIG. 1 shows a computing device configured to recognize handwritten expressions. As illustrated, FIG. 1 includes a user 102, who may input a user handwriting input (e.g., a user stroke sequence) 104 into a computing device 106. The computing device 106 may include a handwriting recognition engine 110 and, optionally, applications 120. The handwriting recognition engine 110 may, in turn, include a symbol graph creation module 112, a segmentation/segment graph module 114, a scoring module 116, and a structure analysis engine 118. The handwriting recognition engine 110 may utilize its components 112-118 to efficiently and accurately recognize the user handwriting input 104 and enable the computing device 106 to output the recognized handwriting 108.

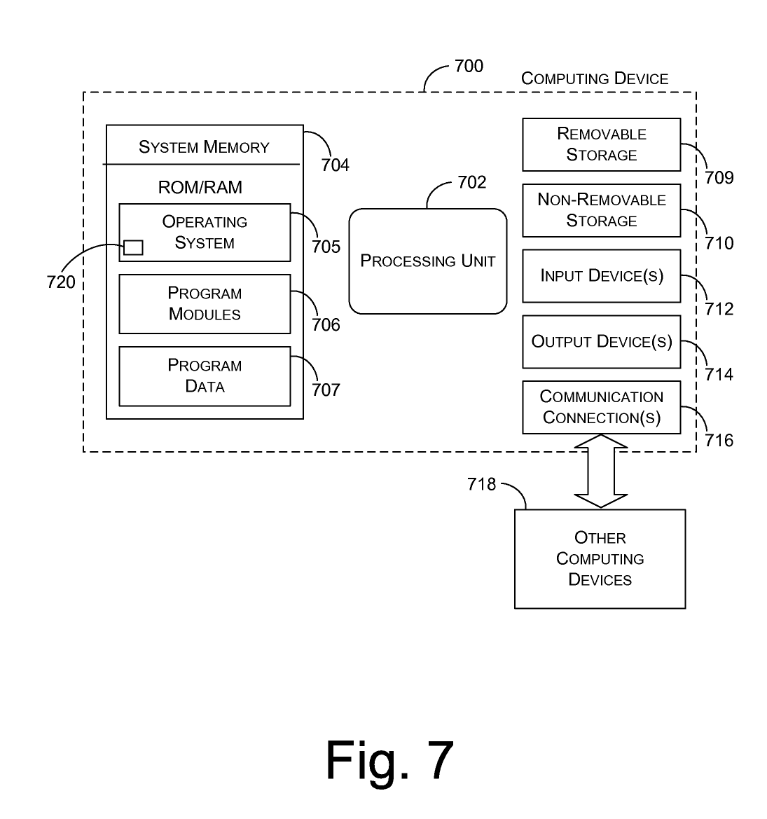

In some embodiments, the computing device 106 may be a Tablet PC or a Personal Digital Assistant (PDA). Computing device 106 may also be one of a laptop computer, a mobile phone, a set top box, a game console, a portable media player, a digital audio player, and the like. The computing device 106 may also be a single- or multi-processor device. In some embodiments, the computing device may be or include a virtual machine. FIG. 7 and its corresponding description below illustrate an exemplary computing device 106 in greater detail.

In other embodiments, the logic of computing device 106, such as handwriting recognition engine 110 and/or applications 120, may be distributed over a plurality of computing devices (not shown), those computing devices may be connected by at least one networking fabric (not shown). For example, the computing devices may be connected by a local access network (LAN), a public or private wide area network (WAN), and/or by the Internet. In some embodiments, the computing devices may implement between themselves a virtual private network (VPN) to secure the communications. Also, the computing devices may utilize any communications protocol known in the art, such as the Transmission Control Protocol/Internet Protocol (TCP/IP) set of protocols. In other embodiments, rather than being coupled by a networking fabric, the computing devices may be locally or physically coupled.

In various embodiments, user handwriting input 104 can be input into computing device 106 using a stylus or the like. User handwriting input 104 can then be directed to the handwriting recognition engine 110 through other applications 120 or the like or can be stored and later sent to the handwriting recognition engine 110. For example, user handwriting input 104 can be directed to applications 120 such as MICROSOFT WORD®, MICROSOFT ONENOTE® or the like and then directed to handwriting recognition engine 120. In some embodiments, handwriting recognition engine 110 may be a separate application and receive user handwriting input 104 before sending it to a word processing or other application. In yet another embodiment (not shown), handwriting recognition engine 120 may be included within an application 120, such as MICROSOFT WORD®.

In some embodiments, user handwriting input 104 may be received by computing device 106 as a series or sequence of strokes. Each stroke may be an individual unit of user handwriting input 104, beginning when a stylus or input mechanism touches an input device of computing device 106 and ending when the stylus breaks contact with the input device (i.e., “lifts up”). A stroke may represent a single symbol or character (e.g. the letter “g”), or a portion of a symbol or character (e.g., the bottom line of an equal sign). In addition to detecting the strokes, the computing device may detect one or more features of the strokes, such as speed of entry, direction in which the stylus was moving at the end of the stroke, etc. The strokes and their features may then be passed to an application 120 or directly to the handwriting recognition engine 110, as discussed above.

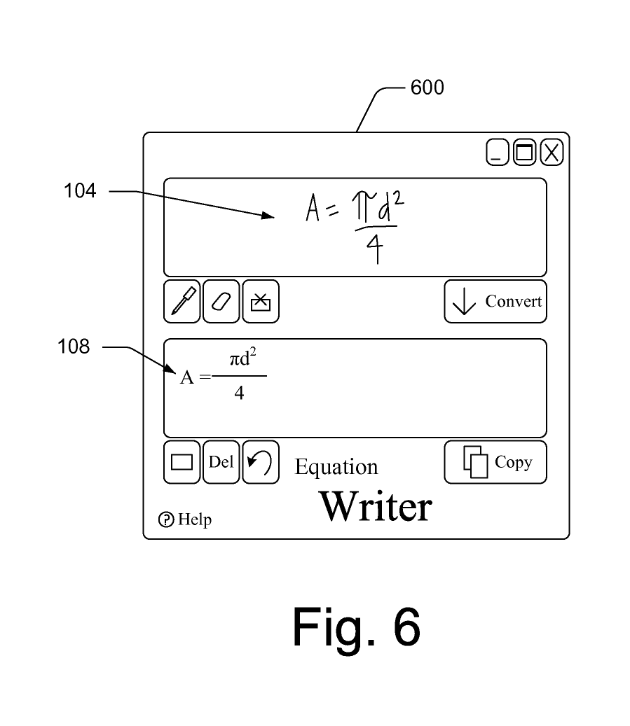

In various embodiments, user handwriting input may be entered through a user interface 600, as illustrated in FIG. 6. In FIG. 6, user handwriting input 104 is input by user 102 into the exemplary user interface 600 which may be displayed by computing device 106. In response, the computing device 106 may display the most likely expression that the user 102 actually entered as recognized handwriting 108. In various embodiments, recognized handwriting 108 may be determined by the handwriting recognition engine 110 and either rendered to the display by the handwriting recognition engine 110 or passed to an application 120 for rendering to the display.

As is further illustrated by FIG. 1, the handwriting recognition engine 110 (hereinafter “engine 110”) may comprise a plurality of modules, such as a symbol graph creation module 112, a segmentation/segment graph creation module 114, a scoring module 116, and a structure analysis engine 118. In other embodiments, the functions of some or all of these modules may be combined into a smaller number of modules, or divided into a great number of modules. Accordingly, the modules and engine 112-118 are shown simply as one exemplary embodiment.

In various embodiments, the symbol graph creation module 112 (hereinafter “symbol graph module 112”) may be a plurality of programming instructions which, when executed by computing device 106, cause the computing device 106 to generate a symbol graph from the received user handwriting input 104.

Upon receiving the strokes and features comprising the user handwriting input 104, the symbol graph module 112 may first decode the input 104 to generate a plurality of candidate symbols and relations between those candidate symbols. In various embodiments, the decoding may be performed with reference to one or more knowledge sources (not shown). The knowledge sources may be stored on computing device 106 or remotely. Also, the knowledge sources may constitute data reflecting machine learning based on prior user input, data entered by the user to aid in decoding future input, and/or templates or libraries generated by another computing device. In some embodiments, the symbol graph module 112 may compare the strokes and their features to data of the knowledge sources to generate a plurality of candidate symbols and relations of those symbols.

The symbol graph module 112, in generating the candidate symbols and relations, may also score those symbols and relations based on how much they resemble symbols and relations of the knowledge sources. In some embodiments, the symbol graph module 112 may then only select the candidate symbols and relations having the highest scores for inclusion in the symbol graph, with what is considered “highest” varying from embodiment to embodiment. In other embodiments, the symbol graph module 112 may include all candidate symbols and relations, regardless of score, in the symbol graph.

In various embodiments, after decoding the strokes and features into candidate symbols, the symbol graph module 112 may create a symbol graph based on the decoded candidate symbols and strokes. The symbol graph need not be a visual component capable of being rendered, but may instead simply be a set of data structures, as is known in the art. Each candidate symbol may have a node associated with it. The node may include the candidate symbol, the stroke the candidate symbol is associated with, and an indication of a relation to a previous candidate symbol. In one embodiment, relations may include “no relation”, signified by an indication ‘N’; a horizontal relationship (for example, in the expression “xy”, ‘y’ has a horizontal relationship with ‘x’), signified by an indication ‘H’; a superscript relationship (for example, in the expression “x^{y}”, ‘y’ has a superscript relationship with ‘x’), signified by an indication ‘P’; and a “below” relationship (for example, a denominator has a “below” relationship with a numerator), signified by an indication ‘E’. In other embodiments, different and/or additional indications may be used. In addition to storing those values, each node of the symbol graph may also store indications of relationships with previous and/or subsequent nodes of prior or following candidate symbols. Such indications may be, for example, pointers to the nodes of the prior or following candidate symbols. Also, in some embodiments, each node may store the score calculated for its candidate symbol and/or scores calculated for its relations/arcs to preceding and subsequent nodes.

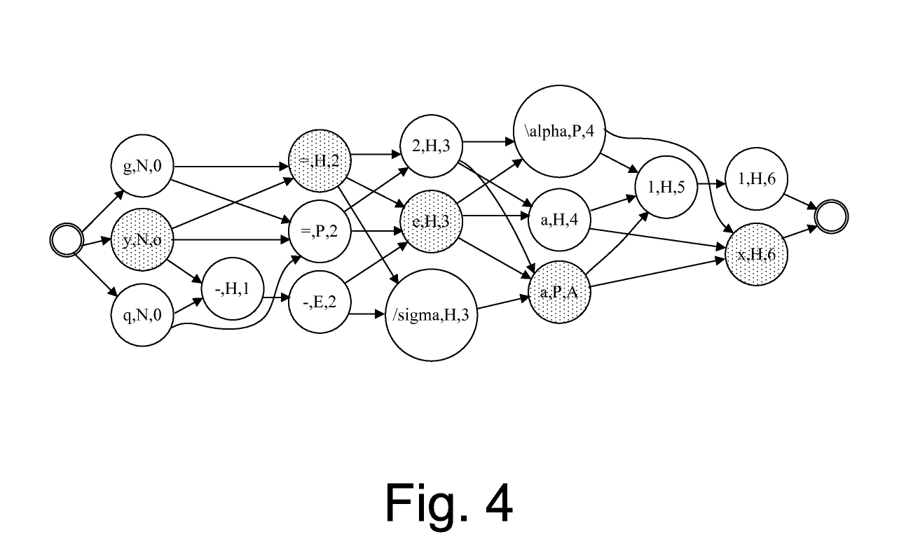

FIG. 4 illustrates an exemplary symbol graph showing a plurality of nodes and relationships. As shown, each node includes a symbol, an indication of a relationship, and an indication of the stroke the candidate symbol is associated with. Also, the double circles at the far left and right of the graph may each indicate a beginning and an end of a sequence of stroke inputs.

Additional details of the decoding and symbol graph creating performed by symbol graph module 112 are described and shown in co-pending U.S. patent application Ser. No. 12/058,506, entitled “Online Handwriting Expression Recognition”, and filed on Mar. 28, 2008. application Ser. No. 12/058,506 is hereby fully incorporated herein by this reference.

As illustrated in FIG. 1, the segmentation/segment graph module 114 (hereinafter “segmentation module 114”) may be a plurality of programming instructions which, when executed by computing device 106, cause the computing device 106 to generate a segment graph and/or determine a plurality of segmentation sequences. In various embodiments, the segmentation module 114 may operate in at least one of two modes. In one embodiment, these two modes may be alternative methods of generating segment sequences/hypotheses for structural analysis. When operating in the first of the two modes, the segmentation module 114 may generate a segment graph from the symbol graph. When operating in the second of the two modes, the segmentation module may determine a plurality of segmentation sequences by selecting symbol sequences from the symbol graph and by combining ones of those symbol sequences to create the segmentation sequences.

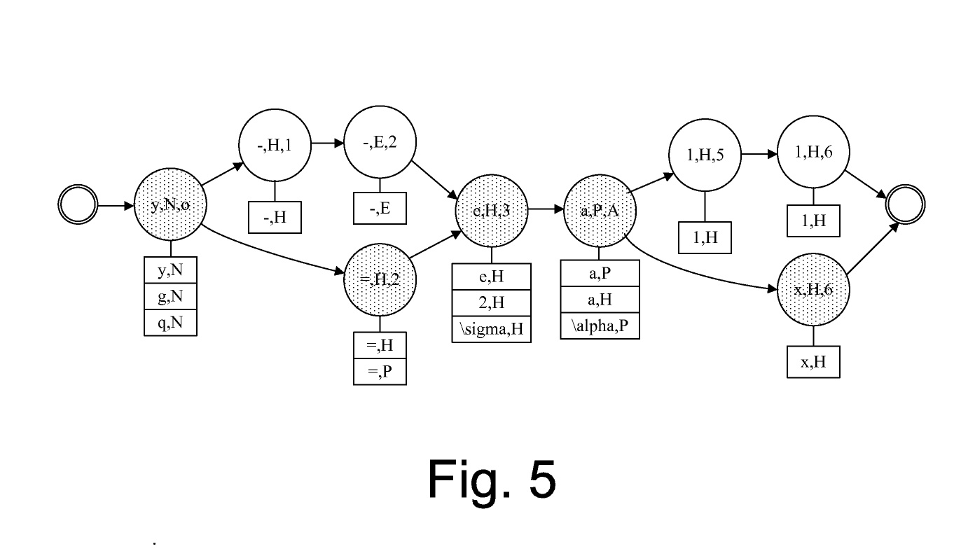

In various embodiments, to create the segment graph, the segmentation module 114 may analyze the symbol graph and find nodes associated with a same stroke. If their preceding nodes are also associated with a preceding, same stroke, the segmentation module 114 may combine the nodes to create a segment. For example, if each of a first pair of nodes is associated with the third stroke and the preceding nodes of the first pair are associated with the first stroke, the segmentation module 114 would combine the first pair of nodes into a first segment. If, however, the preceding node of one of the first pair of nodes was associated with the first stroke and the preceding node of the other node of the first pair was associated with the second stroke, the segmentation module 114 would not combine the first pair of nodes. Further illustration is provided by FIGS. 4 and 5. FIG. 5 represents the segment graph created from the symbol graph of FIG. 4.

In some embodiments, segmentation module 114 may combine nodes by adding the candidate symbol of one node as an attribute of the other node. The node being combined into another node may be the node whose candidate symbol has a lower score, in some embodiments. For example, if a first node has the candidate symbol ‘x’ and a score of 5 (10 being the highest) and a second node has the candidate symbol ‘y’ and a score of 8, the candidate symbol ‘x’ may be added to the second node as an attribute of the second node, creating a segment. The segmentation module 114 may then determine if the preceding arc/edge of the nodes being combined links to the same preceding node. If it does, the segmentation module 114 may delete the arc/edge associated with the lower score and include the remaining arc/edge in the segment. The segmentation module 114 may then determine if the subsequent arc/edge of the nodes being combined links to the same subsequent node. If it does, the segmentation module 114 may delete the arc/edge associated with the lower score and include the remaining arc/edge in the segment. After performing the above operation, the segmentation module 114 may then delete the node associated with the lower score. By creating segments in this manner, the segmentation module 114 inherently preserves a best symbol sequence having as highest score.

In various embodiments, to determine a plurality of segmentation sequences by selecting symbol sequences from the symbol graph and combine ones of those symbol sequences to create the segmentation sequences, the segmentation module 114 may first select a pre-determined number of symbol sequences from the symbol graph. In one embodiment, the segmentation module 114 may select ten symbol sequences having the highest scores.

In some embodiments, to calculate the symbol sequence scores, the segmentation module 114 may perform a tree search of the symbol graph. In one embodiment, the tree search may be an A* search or a stack algorithm. The tree search may determine a plurality of symbol sequences and their scores, in various embodiments.

In various embodiments, the segmentation module 114 may then select symbol sequences from the selected set until a pre-determined number of segmentations is reached. In other embodiments, rather than selecting a pre-determined number of symbol sequences, as described above, the segmentation module 114 may simply select the highest scoring symbol sequences until a pre-determined number of segmentations is reached. In some embodiments, a segmentation may be one or more symbol sequences that may be combined to generate a segment sequence.

In some various embodiments, the segmentation module may then merge symbol sequences having the same segmentation into one segmentation sequence. In some embodiments, this merging may be accomplished in the manner described above of combining nodes into segments.

As mentioned above, engine 110 may also include a scoring module 116. In some embodiments, scoring module 116 may be configured to perform the scoring discussed above with regard to the symbol graph module 112 and segmentation module 114, as well as rescoring the symbol sequences using trigram rescoring. Trigram rescoring may involve expanding the generated symbol graph by adding additional nodes or segments, and by recalculating the score for each relation/arc of the expanded graph. Such trigram rescoring is described in greater detail in U.S. patent application Ser. No. 12/058,501, which is cited in full above.

As illustrated in FIG. 1, engine 110 may also include a structure analysis engine 118. Structure analysis engine 118 may comprise a plurality of programming instructions which, when operated by computing device 106, perform a structure analysis on at least a subset of the segment sequences represented by the segment graph or derived from the symbol graph (as described above) to determine a set of hypotheses for the handwritten expression.

In various embodiments, the subset of the segment sequences may be the sequences having the highest scores, calculated in the manner described above. In other embodiments, the structure analysis engine 118 may perform a structure analysis on all of the segment sequences. The structure analysis itself may take a series of segment sequences as input and calculate a “best” segment sequence, with what is “best” varying from embodiment to embodiment. The structure analysis module may calculate the best segment sequence with reference to one or more knowledge sources, which may be the same knowledge sources discussed above or different knowledge sources. This produces the most likely handwriting input that the user 102 actually input into computing device 106. This is represented as recognized handwriting 108. In one embodiment, recognized handwriting 108 can then be displayed in a user interface as illustrated in FIG. 6 using other applications 120 or using a system component of computing device 106.

In various embodiments, as mentioned above, the computing device 106 may optionally include one or more applications 120. Applications 120 can be any applications that can receive user handwriting input 104, either from the user before handwriting recognition engine 110 receives it, after handwriting recognition outputs recognized handwriting 108, or both. Applications 120 can be applications stored on computing device 106 or stored remotely.

### Exemplary Operations

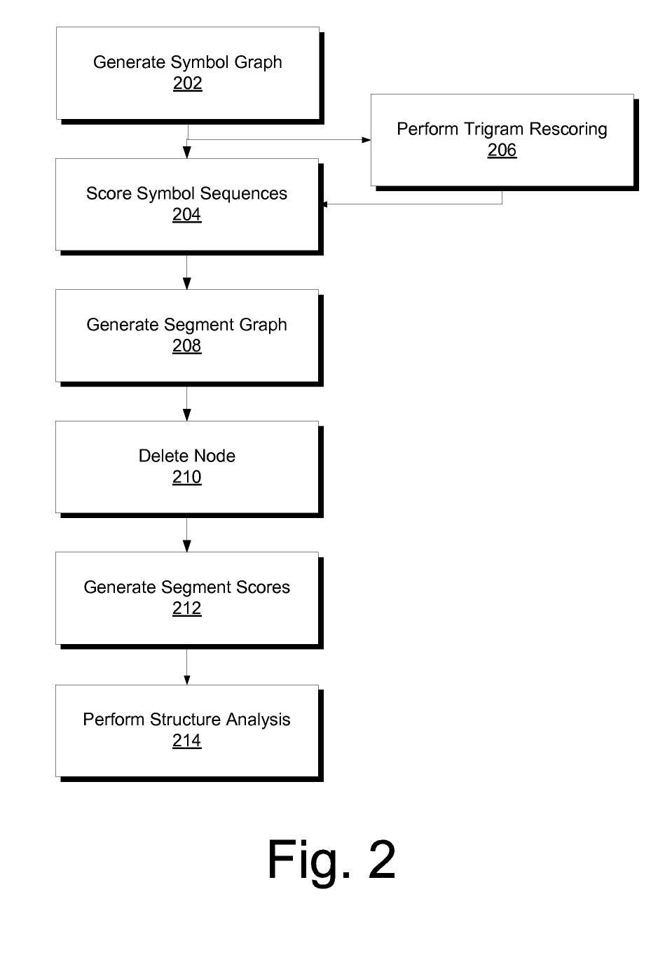

FIG. 2 is a flowchart view of a first set of exemplary operations associated with the overview shown in FIG. 1, in accordance with various embodiments. As illustrated, a computing device may generate a symbol graph to represent a plurality of strokes associated with the handwritten expression, block 202. The symbol graph may include a plurality of nodes, each node corresponding to a combination of a stroke and a candidate symbol for that stroke. In some embodiments, each symbol node may comprise a candidate symbol, a relation of the candidate symbol to a candidate symbol of a predecessor node, and an indication of which stroke of the plurality of strokes the candidate symbol is proposed for.

In various embodiments, the computing device may then perform a tree search on the symbol graph to score symbol sequences comprised of the nodes, block 204. In some embodiments, prior to performing the tree search, the computing device may perform trigram rescoring on symbol sequences of the symbol graph, block 206.

As is shown, the computing device may then a segment graph based on the symbol graph by combining nodes associated with a same stroke if strokes of their preceding nodes are the same, block 208. In combining the nodes, the computing device may add a candidate symbol associated with one node as an attribute of another node with which the one node is being combined. In one embodiment, the one node may have a lower score than the other node. And in performing the adding, the computing device may, in some embodiments, delete the one node and its incoming and outgoing edges after the adding, block 210.

In various embodiments, the computing device may then generate a segment score by determining a max score of the nodes combined to create the segment, block 212. In some embodiments, each segment may comprise a candidate symbol, a relation of the candidate symbol to a candidate symbol of a predecessor segment, an indication of which stroke of the plurality of strokes the candidate symbol is proposed for, and a list of one or more alternative candidate symbols.

As illustrated, the computing device may then perform a structure analysis on at least a subset of a plurality of segment sequences represented by the segment graph to determine a set of hypotheses for the handwritten expression, block 214. In some embodiments, the subset of the segment sequences may be the sequences having the highest scores.

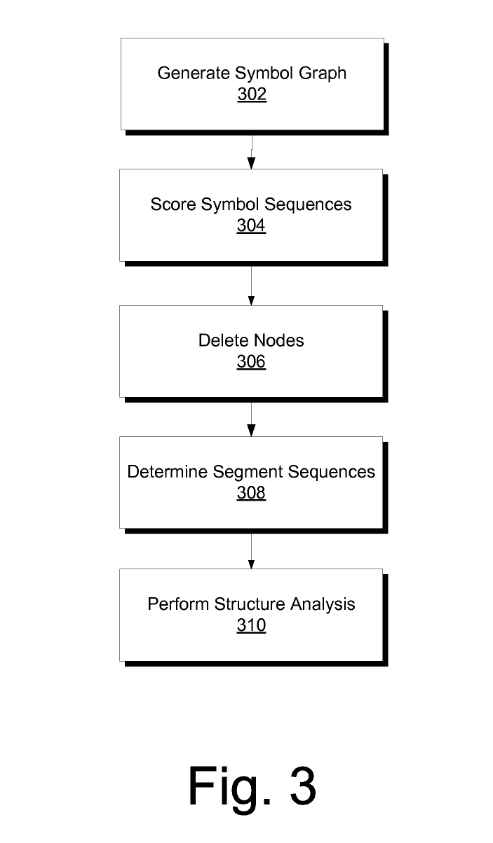

FIG. 3 is a flowchart view of a second set of exemplary operations associated with the overview shown in FIG. 1, in accordance with various embodiments. As illustrated, a computing device may generate a symbol graph to represent a plurality of strokes associated with the handwritten expression, block 302. In various embodiments, the computing device may then perform a tree search on the symbol graph to score symbol sequences comprised of the nodes, block 304. In some embodiments, the computing device may then delete a number of symbol sequences having the lowest scores, block 306.

As is shown, the computing device may then determine a plurality of segment sequences by selecting a number of symbol sequences from the symbol graph and combining symbol sequences having a same segmentation, block 308. In one embodiment, the selected symbol sequences may be the symbol sequences having the highest scores. In various embodiments, the selecting may comprise selecting a subset of the selected symbol sequences until a predetermined number of segmentations is reached. Also, in some embodiments, the combining may comprise adding candidate symbols of a first symbol sequence as attributes of nodes of a second symbol sequence, each candidate symbol added to a node associated with a same stroke as the candidate symbol.

In various embodiments, the computing device may then perform a structure analysis on at least a subset of the segment sequences to determine a set of hypotheses for the handwritten expression, block 310.

### Exemplary Computing Device

FIG. 7 illustrates an exemplary computing device 700 that may be configured to facilitate compression of a source file. For example, computing device 700 may be a tablet PC or PDA configured to accept handwritten data input.

In various embodiments, computing device 700 may include at least one processing unit 702 and system memory 704. Depending on the exact configuration and type of computing device, system memory 704 may be volatile (such as RAM), non-volatile (such as ROM, flash memory, etc.) or some combination of the two. System memory 704 may include an operating system 705, one or more program modules 706, and may include program data 707. The operating system 705 may include a component-based framework 720 that supports components (including properties and events), objects, inheritance, polymorphism, reflection, and provides an object-oriented component-based application programming interface (API), such as that of the .NET™ Framework manufactured by Microsoft Corporation, Redmond, Wash.

Computing device 700 may also include additional data storage devices (removable and/or non-removable) such as, for example, magnetic disks, optical disks, or tape. Such additional storage is illustrated in FIG. 7 by removable storage 709 and non-removable storage 710. Computer storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of device 700.

In various embodiment, any or all of system memory 104, removable storage 709, and non-removable storage 710, may store programming instructions which, when executed, implement some or all of the above-described operations of handwriting recognition engine 110.

Computing device 700 may also have input device(s) 712 such as a touch input device (in some embodiments with an accompanying stylus), keyboard, mouse, pen, voice input device, etc. Output device(s) 714 such as a display, speakers, printer, etc. may also be included. These devices are well know in the art and need not be discussed at length here.

Computing device 700 may also contain communication connections 716 that allow the device to communicate with other computing devices 718, such as over a network. Communication connections 716 are one example of communication media. Communication media may typically be embodied by computer readable instructions, data structures, program modules, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, references are made above in the detailed description to the accompanying drawings that are part of the disclosure and which illustrate embodiments. Other embodiments may be utilized and structural or logical changes may be made without departing from the scope of the disclosure. Therefore, the detailed description and accompanying drawings are not to be taken in a limiting sense, and the scope of embodiments is defined by the appended claims and equivalents.

Various operations may be described herein as multiple discrete operations in turn, in a manner that may be helpful in understanding embodiments; however, the order of description should not be construed to imply that these operations are order-dependent. Also, embodiments may have fewer operations than described. A description of multiple discrete operations should not be construed to imply that all operations are necessary.

The description may use perspective-based descriptions such as up/down, back/front, and top/bottom. Such descriptions are merely used to facilitate the discussion and are not intended to restrict the scope of embodiments.

The terms “coupled” and “connected,” along with their derivatives, may be used. These terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

1. A method comprising:
generating, by a computing device configured to interpret a handwritten expression, a symbol graph to represent a plurality of strokes associated with the handwritten expression, the symbol graph including a plurality of nodes, each node corresponding to a combination of a stroke and a candidate symbol for that stroke;
generating, by the computing device, a segment graph based on the symbol graph by combining nodes associated with a same stroke if strokes of their preceding nodes are the same; and
performing, by the computing device, a structure analysis on at least a subset of a plurality of segment sequences represented by the segment graph to determine a set of hypotheses for the handwritten expression.

2. The method of claim 1 further comprising performing a tree search on the symbol graph to score symbol sequences comprised of the nodes.

3. The method of claim 2 further comprising generating a segment score by determining a max score of the nodes combined to create the segment.

4. The method of claim 1, wherein the combining further comprises adding a candidate symbol associated with one node as an attribute of another node with which the one node is being combined.

5. The method of claim 4 further comprising deleting the one node and its incoming and outgoing edges after the adding.

6. The method of claim 4, wherein the one node has a lower score than the other node.

7. The method of claim 1 further comprising performing trigram rescoring on symbol sequences of the symbol graph.

8. The method of claim 1, wherein the subset of the segment sequences are the sequences having the highest scores.

9. The method of claim 1, wherein each symbol node comprises a candidate symbol, a relation of the candidate symbol to a candidate symbol of a predecessor node, and an indication of which stroke of the plurality of strokes the candidate symbol is proposed for.

10. The method of claim 1, wherein each segment comprises a candidate symbol, a relation of the candidate symbol to a candidate symbol of a predecessor segment, an indication of which stroke of the plurality of strokes the candidate symbol is proposed for, and a list of one or more alternative candidate symbols.

11. A computer-readable medium having computer-executable instructions that, when executed on one or more processors, perform operations comprising:
generating a symbol graph to represent a plurality of strokes associated with a handwritten expression, the symbol graph including a plurality of nodes, each node corresponding to a combination of a stroke and a candidate symbol for that stroke;
determining a plurality of segment sequences by selecting a number of symbol sequences from the symbol graph and combining symbol sequences having a same segmentation; and
performing a structure analysis on at least a subset of the segment sequences to determine a set of hypotheses for the handwritten expression.

12. The computer-readable medium of claim 11, wherein the computer-executable instructions perform operations further comprising performing a tree search on the symbol graph to score symbol sequences comprised of the nodes.

13. The computer-readable medium of claim 12, wherein the selected symbol sequences are the symbol sequences having the highest scores.

14. The computer-readable medium of claim 12, wherein the computer-executable instructions perform operations further comprising deleting a number of symbol sequences having the lowest scores.

15. The computer-readable medium of claim 11, wherein the determining further comprises selecting a subset of the selected symbol sequences until a predetermined number of segmentations is reached.

16. The computer-readable medium of claim 11, wherein the combining further comprises adding candidate symbols of a first symbol sequence as attributes of nodes of a second symbol sequence, each candidate symbol added to a node associated with a same stroke as the candidate symbol.

17. The computer-readable medium of claim 11, wherein each segment comprises a candidate symbol, a relation of the candidate symbol to a candidate symbol of a predecessor segment, an indication of which stroke of the plurality of strokes the candidate symbol is proposed for, and a list of one or more alternative candidate symbols.

18. A tablet personal computer comprising:
a processor;
an input mechanism configured to receive a handwritten expression; and
a plurality of executable instructions configured to be operated by the processor and to program the computing device to:
generate a symbol graph to represent a plurality of strokes associated with a handwritten expression, the symbol graph including a plurality of nodes, each node corresponding to a combination of a stroke and a candidate symbol for that stroke;
perform a tree search on the symbol graph to score symbol sequences comprised of the nodes;
generate a segment graph based on the symbol graph by combining nodes associated with a same stroke if strokes of their preceding nodes are the same, the combining including adding a candidate symbol associated with one node as an attribute of another node with which the one node is being combined and deleting the one node and its incoming and outgoing edges after the adding; and
perform a structure analysis on at least a subset of a plurality of segment sequences represented by the segment graph to determine a set of hypotheses for the handwritten expression, wherein the subset of the segment sequences are the sequences having the highest scores.

19. The tablet personal computer of claim 18 wherein the plurality of executable instructions are further configured to program the computing device to generate a segment score by determining the max score of the nodes combined to create the segment.

20. The tablet personal computer of claim 18 wherein the plurality of executable instructions are further configured to program the computing device to perform trigram rescoring on symbol sequences of the symbol graph.
